(19) United States
(12) Patent Application Publication
(10) Pub. No.: US 2015/0362370 A1
(43) Pub. Date: Dec. 17, 2015

(54) SENSOR-FREE IMAGE-BASED AND COMPUTATIONALLY EFFECTIVE APPROACH TO VEHICULAR, INDUSTRIAL AND DOMESTIC AIR POLLUTION ESTIMATION AND CONTROL

(71) Applicants: Khaled Ali ABUHASEL, AI Kharj (SA); Saleh A. ALKAHTANI, AI Kharj (SA); Abdullah M. ILlYASU, AI Kharj (SA)

(72) Inventors: Khaled Ali ABUHASEL, AI Kharj (SA); Saleh A. ALKAHTANI, AI Kharj (SA); Abdullah M. ILlYASU, AI Kharj (SA)

(21) Appl. No.: 14/303,383

(22) Filed: Jun. 12, 2014

(51) Int. Cl. G01J 5/00

(52) U.S. Cl. CPC G01J 5/0014

(57) ABSTRACT

A system and a method for quantifying the amount and toxicity of a point source gaseous discharge without contacting or physically sampling the point source gaseous discharge, includes: a digital camera capable of capturing multiple images of the point source gaseous discharge and an advanced thermographic camera capable of capturing multiple infrared images of the point source gaseous discharge; and processing circuitry configured to: delineate a smoke region around a point source discharge according to a temperature profile around the point source determined from the normal and infrared images of the space around the point source; digitally record a temperature profile of the smoke region; fuse the aggregated information from the separate images captured using the normal thermographic cameras in order to obtain the emissivity and radiation intensity of one or more components of the point source gaseous discharge in the smoke region from a static database; determine the identity of the components of the point source gaseous discharged by comparing temperature variations of the temperature profile of the smoke region with the emissivity and radiation intensity from the static database; and determine the amount of the components of the point source gaseous discharge through a fuzzy logic controller by relating the properties of the components with the temperature profile the emissivity of the components in the static database.

### BACKGROUND

1. Field of the Invention

The exemplary embodiments described herein relate to a sensor-free image based computationally effective approach to Vehicular, Industrial and Domestic Air Pollution Estimation and Control.

2. Background of the Invention

Airborne particulate matter is a serious threat to both people's health and the environment. It is also the primary cause for visibility degradation in urban metropolitan areas. An optical technique to measure air visibility (and hence an estimate of some kinds of air pollution) using cameras and other sensors available on smartphones can be used.

Atmospheric visibility refers to the clarity with which distant objects are perceived. It is important as a measure of air quality, driving safety, and for tourism. Without the effects of manmade air pollution, the natural visual range would be nearly 140 miles. The atmospheric pollutants that most often affect visibility exist as haze aerosols which are tiny particles (10 um and smaller) dispersed in air that scatter sunlight, imparting a distinctive gray hue to the sky.

The sources of air pollutants include the different byproducts that result from the burning of different fuels used in vehicle, industrial and domestic processes. Transportation is responsible for a large percentage of the greenhouse gas emissions. Emissions caused by traffic are mainly those of carbon dioxide, carbon monoxide, nitrogen oxides, and small dust particles. The industries are responsible for emissions of carbon monoxide, carbon oxide, sulphur dioxide, nitrogen oxides, small dust particles, VOC, methane, ammonia and radioactive radiation. During energy generation, chemicals such as methane are released into the air as a result of oil and natural gas extraction. The combustion of coal and natural gas for electricity production causes the release of sulphur dioxide, nitrogen oxides and carbon oxide into the air. Domestic air pollution includes carbon monoxide generated by the gas and heaters, stoves and cookers; local smoke from bonfires, garden incinerators and barbecues, and smoke from the burning of agriculture waste. For preventing long exposure to this type of harmful air pollution that causes adverse health effects, it motivates a growing interest to develop efficient techniques to monitor this type of pollution.

Therefore, there is a need for a simple, reliable air pollution monitoring method which uses equipment of reasonable cost and which can be easily used in remote location. Moreover, there is a need to monitor real time air pollution at multi-locations.

### SUMMARY

In one embodiment, there is provided a process for quantifying the amount and toxicity of a point source gaseous discharge without contacting or physically sampling the point source gaseous discharge, comprising: delineating a smoke region around a point source discharge according to a temperature profile around the point source determined from a digital infrared image of the space around the point source; digitally recording a temperature profile of the smoke region, wherein the temperature profile comprises pixels of a digital infrared image, with each pixel representing a temperature; obtaining the emissivity and radiation intensity of one or more components of the point source gaseous discharge in the smoke region from a static database; determining the identity of the components of the point source gaseous discharge by comparing temperature variations of the temperature profile of the smoke region with the emissivity and radiation intensity from the static database; and determining the amount of the components of the point source gaseous discharge through a fuzzy logic controller by relating the properties of the components with the temperature profile the emissivity of the components in the static database.

In another embodiment, the step of digitally recording a temperature profile of the smoke region comprises using temperature variations to obtain the temperature of every pixel in the digital infrared image.

In another embodiment, the step of obtaining the emissivity and radiation intensity of the components of the point source gaseous discharge comprises calculating the smoke radiation intensity using the equation:

R_{S}=εₛσT⁴

wherein R_{S} is the smoke radiation intensity in /m², εₛ is the dimensionless smoke emissivity; σ is the Stefan-Boltzmann constant=5.67×10⁻⁸ W/m², and T is temperature in Kelvin.

In another embodiment, the step of obtaining the emissivity and radiation intensity of the components of the point source gaseous discharge comprises using a lambda calculation to compare all of oxygen in the gaseous discharge to all of Carbon and Hydrogen in the gaseous discharge.

In another embodiment, the step of obtaining the emissivity and radiation intensity of the components of the point source gaseous discharge comprises obtaining the emissivity and radiation intensity of one or more components of the point source gaseous discharge in the smoke region from a static database, which is a smoke source static data together with dynamic properties about the gaseous discharge at the time of measurement.

In another embodiment, the dynamic properties about the gaseous discharge include at least one of weather properties and time properties.

In another embodiment, the weather properties include at least one of a temperature property, a wind property and a fog property.

In another embodiment, the time properties include at least one of a cool morning breeze, a cool evening breeze and a heat of a day.

In a second aspect, the present disclosure includes a system for quantifying the amount and toxicity of a point source gaseous discharge without contacting or physically sampling the point source gaseous discharge, comprising: a camera capable of capturing digital infrared image; and processing circuitry coupled with the camera, the processing circuitry configured to: delineate a smoke region around a point source discharge according to a temperature profile around the point source as determined from a digital infrared image of the space around the point source; digitally record a temperature profile of the smoke region, wherein the temperature profile comprises pixels of a digital infrared image, with each pixel representing a temperature;
obtain the emissivity and radiation intensity of one or more components of the point source gaseous discharge in the smoke region from a static database; determine the identity of the components of the point source gaseous discharged by comparing temperature variations of the temperature profile of the smoke region with the emissivity and radiation intensity from the static database; and determine the amount of the components of the point source gaseous discharge through a fuzzy logic controller by relating the properties of the components with the temperature profile and the emissivity of the components in the static database.

In another embodiment, the processing circuitry uses temperature variations to obtain the temperature of every pixel in the digital infrared image.

In another embodiment, the processing circuitry calculates the smoke radiation intensity using the equation:

R_{S}=εₛσT⁴

wherein R_{S} is the smoke radiation intensity in /m², εₛ is the dimensionless smoke emissivity; σ is the Stefan-Boltzmann constant=5.67×10⁻⁸ W/m², and T is temperature in Kelvin.

In another embodiment, the processing circuitry uses a lambda calculation to determine the amount of all of oxygen in the gaseous discharge to all of Carbon and Hydrogen in the gaseous discharge.

In another embodiment, the processing circuitry obtains the emissivity and radiation intensity of one or more components of the point source gaseous discharge in the smoke region from a static database, which consists of a static data about the smoke source together with dynamic properties about the gaseous discharge at the time of measurement.

In another embodiment, the dynamic properties about the gaseous discharge include at least one of weather properties and time properties.

In another embodiment, the weather properties include at least one of a temperature property, a wind property and a fog property.

In another embodiment, the weather properties include at least one of a cool morning breeze, and a heat of a day.

In a second aspect the present disclosure includes a non-transitory computer-readable medium storing executable instructions, which when executed by a computer processor, cause the computer processor to execute a method comprising: delineating a smoke region around a point source discharge according to a temperature profile around the point source determined from a digital infrared image of the space around the point source; digitally recording a temperature profile of the smoke region, wherein the temperature profile comprises pixels of a digital infrared image, with each pixel representing a temperature; obtaining the emissivity and radiation intensity of one or more components of the point source gaseous discharge in the smoke region from a static database; determining the identity of the components of the point source gaseous discharged by comparing temperature variations of the temperature profile of the smoke region with the emissivity and radiation intensity from the static database; and

determining the amount of the components of the point source gaseous discharge through a fuzzy logic controller by relating the properties of the components with the temperature profile the emissivity of the components in the static database.

### BRIEF DESCRIPTION OF THE DRAWINGS

FIG. 1 depicts different steps involved in an exemplary image-based sensor-less approach to quantify the amount and toxicity of smoke discharge from a source;

FIG. 2 depicts a fuzzy logic controlled decision maker;

FIG. 3 depicts a dual energy decomposition method, by way of a flowchart; and

FIG. 4 shows a schematic diagram of an exemplary processing system.

### DETAILED DESCRIPTION OF THE EMBODIMENTS

The characteristics and advantages of an exemplary embodiment are set out in more detail in the following description, made with reference to the accompanying drawings.

A wholly image-based, sensor-less and contact-free approach (system or device) is disclosed to estimate the quantity and toxicity of smoke and gaseous discharges emanating from the vehicular, industrial or domestic burning of organic substances. The approach in the form of a system, device and/or process utilizes the properties of images captured via infra-red thermography (emissivity, which measures the ability of the discharge to absorb and emit radiation over certain wavelengths, and other factors such as temperature, the emission medium, pressure, etc.) and those from images captured using normal cameras and features of interest (FOI) therefrom to aggregate thermo-graphic sub-bands and features of the infra-red images that are needed to discern the color of a gaseous or particulate-containing discharge; its amount; and to localize the dynamic properties of the discharge such as its shape, size, diffusion, etc. These qualities are then integrated as a measure of the quantity and toxicity of the discharge into the environment. Compared alongside commercial versions available in the market, the disclosed system, device and process are, more portable and contact-free, they are ideal for integration by relevant authorities in covert surveillance systems aimed at regulating gaseous or particulate-containing discharges to help curtail the effects of air pollution.

Gases in general and especially those from the burning of hydrocarbons are known to absorb or emit radiation over certain wavelengths, a property loosely known as emissivity. The colorless nature of the hydrocarbon gases is attributed to the fact that there is an equal effect to light on all visible wavelengths, which is itself attributed, in part, to the absorption of the light by such gases.

In addition to this, the invisible color in the hydrocarbon gases is caused by 1) the large distance separating the particles in the gases; 2) the low emission energy that such gases have; 3) the small size of the molecules and their bonds, which inhibit the ability of the molecules to absorb or reflect light; and, finally, 4) the low densities of the by-products of the combustion process.

Smoke is a general term used to describe the cloudy, hazy discharge emanating from the burning of organic substances (e.g., gaseous and/or particulate-containing discharge). It differs from particulate matter (PM) in that it results only from the burning of organic substances while PM consists of small solids and/or liquids suspended in air and do not necessarily arise from combustion.

TABLE I

| | | Chemical | | | |
|---|---|---|---|---|---|
| S/No. | Chemical Name | Formula | Toxicity | Colour | Odour |
| 1 | Hydrogen | H₂ | None | Colourless | Odourless |
| 2 | Carbon | C₂ | None | Colourless | Odourless |
| 3 | Nitrogen | N₂ | None | Colourless | Odourless |
| 4 | Oxygen | O₂ | None | Colourless | Odourless |
| 5 | Carbon dioxide | CO₂ | None | Colourless | Odourless |
| 6 | Ammonia | NH₄ | Toxic | Colourless | Penetrating |
| 7 | Nitrogen dioxide | NO₂ | Very | Reddish | Irritating |
| | | | Toxic | Brown | |
| 8 | Nitrogen oxide | NO | Very | Colourless | Odourless |
| | | | Toxic | | |
| 9 | Carbon monoxide | CO | Very | Colourless | Odourless |
| | | | Toxic | | |

Assuming the availability of a constantly updated database consisting of specific details of a smoke discharge source (S) (for example, the rear exhaust pipes in vehicles or chimneys found in industrial or domestic discharge sources) it is possible to retrieve some vital information that would help in estimating the amount and severity as a measure of toxicity of the discharge emanating from a source. In the case of a vehicle smoke discharge source, for example, these data include the vehicle type, fuel type and its grade, vehicle maintenance records, traffic violations, and etc. These data are used to suggest the likely composition, volume, temperature, etc. of the smoke exiting the discharge unit for both complete and incomplete combustion of the fuel used to power the vehicle. This information can be referred as static data about a source. Table 1 summarizes the types and properties of gases realized from the combustion of hydrocarbons in a vehicle.

TABLE 2

| | Smoke | | Likely |
|---|---|---|---|
| S/No. | Colour | Mechanical State | Composition |
| 1 | White | This type of smoke is caused by the | |
| | | presence of vaporized water and/or | |
| | | unburned fuel in the exhaust. It is also | |
| | | indicative of a misfiring cylinder or a | |
| | | badly damaged engine. | |
| 2 | Blue | This type of smoke suggests high | |
| | | concentrations of unburned or partially | |
| | | oxidised fuel or lubricating oil in the | |
| | | exhaust. It is also typical of engine | |
| | | operation at low temperatures or a sign | |
| | | of high oil consumption. | |
| 3 | Black | Smoke | Mainly |
| | | | particles |
| | | | of carbon |

Notwithstanding the chemical description involved, smoke emissions from any source, say a vehicle, are known to produce smoke discharges of different colours depending largely on the nature of the combustion it underwent. What is not readily discernable, however, is the colour of the respective molecules in the gas fume, the quantity of each, and hence, their respective toxicity and contribution to environmental pollution. In the case of vehicular smoke discharges, the colours of these fumes vary from between the two extremes of what is perceived as white and black smoke. In between them is a transition through different shades of grey and blue. These variations including the likely composition of the molecules in the fume are summarized in Table 2. The different types of smoke realized from the combustion process in vehicles are listed in Table 2.

The described approach to estimate the amount and toxicity of smoke discharges from any source (vehicular, industrial or domestic) integrates some state-of-the-art image processing techniques to manipulate the various images captured using different types of cameras with different computational intelligence techniques, most notably fuzzy logic control. Based on the techniques of infrared thermography, using an infrared camera, which captures thermal radiations emitted and/or absorbed by targets, the emissivity of a source defined in equation (1) can be determined:

R_{S}=εₛσT⁴ (1)

where R_{S} is the smoke radiation intensity in /m²; εₛ is the dimensionless smoke emissivity; σ is the Stefan-Boltzmann constant=5.67×10⁻⁸ W/m²; and T is temperature in Kelvin.

To accomplish this, the described approach modifies and extends similar applications that are widely used to quantify the emissivity of flames in burning fires. The modifications introduced entail the use of the static data about the smoke source (the vehicle and traffic data in the case of vehicular smoke) together with a few other extraneous, yet dynamic, properties about the emissions from the source at the time of measurement such as weather (temperature, wind, fog) and time (for example, whether or not the measurement is done during the heat of the day or the cool morning breeze, etc.).

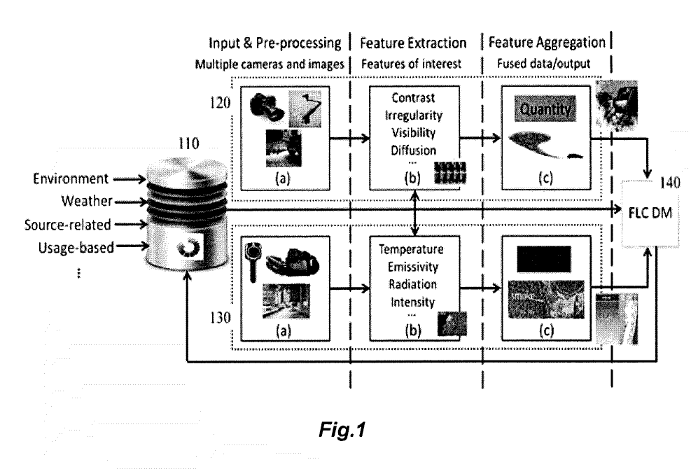

FIG. 1 depicts the different steps involved in the proposed image-based sensor-less approach to quantify the amount and toxicity of smoke discharge from a source (in this case a vehicle, but it could be extended to any type of smoke discharge source, i.e. industrial or domestic) to infer the combustion dynamics and quantify the likely temperature of the exhaust discharge, T_{E}.

According to the black body radiation law, infrared radiation is emitted by all objects above the absolute zero temperature. Therefore, every object can be seen with or without illumination. The amount of radiation emitted, however, depends on the temperature of the object. Utilizing this information, variations in temperature can be seen. From a viewpoint of thermography, using a thermal imaging camera ‘warm’ objects are easily discernable in comparison with the ‘cool’ objects that make up the background, thereby allowing the objects to stand out clearly. This is the principle behind the ability of firefighters to see through thick smoke in fires. It enables them to easily find persons trapped in fires and localize the base of the fire.

Adopting an inverted interpretation to this principle, such that background objects are characterized by ‘warm’ colours (temperatures over 5000K) to yield ‘cool’ objects, while smoke has ‘cool’ colours and is therefore a ‘warm’ object. These warm objects are usually bluish-white in colour with temperatures in the range 2000 to 3000K. This simple interpretation simplifies the separation of smoke from a discharge unit from its surrounding background. In such a manner temperature variations could be used to produce smoke discharge images that do need further analysis to clearly delineate the smoke regions from the background objects.

From the temperature variations that make up this image the temperature of every pixel in the temperature image I_{T} can be obtained. Meanwhile, using the static data, the emissivity and radiation intensity can be obtained. The widely used lambda calculation compares all of the oxygen in the exhaust gases to all of the Carbon and Hydrogen in the gases (Water, which contains both Hydrogen and Oxygen, is determined by estimation using the fraction of the sum of CO to CO2 in the exhaust). The tailpipe should contain low levels of Oxygen, HC and CO (the sources of combustion), but high levels of CO2 and Water Vapour. They will be at the same balance as the intake manifold gases. Nothing is lost or gained, but just converted. It really does not matter where the gases are measured, or how efficient the combustion process is, hence, the total emissivity in the temperature image can be obtained also.

The temperature variations are used to discern the constituent parts of the gaseous mixture in the smoke discharge and to estimate how many such parts there are in the smoke discharged. In other words, it can be used to estimate the quantity of the smoke and its composition (or loosely, its quality).

In between the steps enumerated earlier, the different stages of the proposed approach (FIG. 1) are used to extract the necessary features from the different images that were captured; aggregate these features with relevant ones form the static database and those from the extraneous contributions of weather, etc.

Following this, a fuzzy controller stage is then used to relate the gas properties (both as colourless emissions and as approximations related to the smoke discharge source, for example, the properties listed in Table 2 in the case of a vehicular smoke discharge source) with the temperature image (T_{E}) and the emissivity values obtained using it. The result from this stage is an estimation of the amount of smoke discharged and its toxicity (i.e. as broader variations in the cool and warm objects in T_{E} and as tiny changes in it respectively), a delineation that is akin to classifying the constituent parts in the discharge.

Finally, where this estimate exceeds some prescribed limits, the authorities concerned could impose appropriate penalties to deter offenders and enforce compliance with safe emission levels.

The different stages of the approach are enumerated below.

The database 110 comprises of information gathered from different sources. Although most of the data stored in the database is static, it is assumed that decisions taken on any the severity of the discharge from a point source can be uploaded on the database in real-time. The table 3 lists some exemplary data that should be in the database.

TABLE 3

| Type | Characteristics/purpose | Source | Example |
|---|---|---|---|
| Environmental | Area specific data about the | Different | Average visibility of |
| | environment where the device | government | an area. |
| | is deployed for use. It | agencies and | |
| | accounts for all non-smoke | departments that | |
| | PM present in the air. | collate such data. | |
| Weather | Hourly, daily, seasonal, etc. | Different | Changes in weather |
| | variations in weather | government | relative to time of |
| | (temperature, humidity, etc.) | agencies and | day, season, etc. |
| | | departments that | |
| | | collate such data. | |
| Source-related | Data specific to the smoke | Manufacturers of | Vehicle registration |
| | discharge unit (source). | the source, traffic | details, owner, |
| | | and vehicle | type/grade of fuel, |
| | | inspection | its temperature and |
| | | departments, etc. | other dynamics |
| | | | depending on the |
| | | | source and its |
| | | | combustion process |
| Usage-based | Data collated some period of | Traffic and vehicle | Vehicle |
| | time related to the use of the | inspection | maintenance records |
| | smoke discharge unit (source). | departments, etc. | and history |
| Thresholds | Different thresholds set by | Traffic and vehicle | Approved smoke |
| | regulatory authorities | inspection | discharge limits |
| | depending on the type of | departments, | depending on the |
| | smoke discharge unit (source). | pollution control | type and use of the |
| | | units, etc. | smoke discharge |
| | | | unit (source) |
| Others | All other data needed to | All relevant | Any other |
| | effectively estimate | authorities | information not |
| | discharges emanating from a | | covered by the other |
| | smoke discharge unit (source). | | data types |

Digital (Normal) Imaging Unit 120 is further divided into three sub-units (a), (b) and (c), which account for the pre-processing, feature extraction and feature aggregation steps needed for the disclosed approach (system or device) to function effectively. These 3 sub-units are explained in the sequel.

One sub-unit is input/pre-processing unit 120(a). Multiple images are captured using multiple types of state-of-the-art digital cameras. In the case of a vehicular point source discharge unit (or source) at least 3 of these cameras will be focused on the rear (tail) end of the vehicle. These images will capture multiple images of the left, centre and right ends of the tail (rear)-end of the vehicle. This will ensure that the regions around the vehicle exhaust pipe are effectively captured by the images. In addition, such a set up will enable the capture of discharges emanating from vehicles with more than one discharge (exhaust) unit. The images captured at this stage will be pre-processed by preparing different variants (RGB, Greyscale, binary (black and white), etc.) of the images.

One sub-unit is feature extraction 120 (b). Using the preprocessed variants of the images, this sub-unit is solely dedicated to extracting the necessary features required to discriminate the total area covered by the smoke plume emanating from a smoke discharge unit (source). Such features of interest include contrast, irregularity, diffusion and the extent to which the visibility is impeded by the plume discharged from a point source unit. Where required this sub-unit is designed to make use data from the thermographic Imaging Unit (unit 130) as depicted in FIG. 1.

Another sub-unit is Feature Aggregation 120 (c). This sub-unit fuses the features of interest gathered earlier in sub-unit 120 (b) in order to effectively discriminate the total area covered by the plume discharged by the point source discharge unit.

Similar to the digital (normal) imaging unit in 120, the thermographic imaging unit 130 is further divided into three sub-units (a), (b) and (c), which account for the pre-processing, feature extraction and feature aggregation steps needed for the disclosed approach (system or device) to function effectively. These 3 sub-units are explained in the sequel.

One sub-unit is Input/Pre-processing 130 (a). Multiple images will be captured using multiple advanced thermographic cameras that capture infrared images. In the case of a vehicular smoke discharge unit (source) at least 3 of these cameras will be focused on the rear (tail) end of the vehicle. These images will capture multiple images of the left, centre and right ends of the tail (rear)-end of the vehicle. This will ensure that the regions around the vehicle exhaust pipe are effectively captured by the images. In addition, such a set up will enable the capture of discharges emanating from vehicles with more than one discharge (exhaust) unit. The images captured at this stage will be pre-processed in a fashion similar that in sub-unit 120 (a) for the digital images.

One sub-unit is Feature extraction 130 (b). Using the preprocessed variants of the infrared images captured, this sub-unit is solely dedicated to extracting the necessary features that can be combined with the static data in the database (unit 110) in order to realise the temperature image I_{T} as explained in other sections of this disclosure. To do this, the information in the database will be used to determine the emissivity and radiation intensity of different areas of the infrared images. Where needed this sub-unit could be designed to make use data from the Digital camera unit (unit 120) as depicted in FIG. 1.

Another sub-unit is Feature Aggregation 130 (c). This sub-unit fuses the features of interest gathered earlier in sub-unit 130 (b) in order to determine the different colours around the point source smoke of which are of the smoke plume discharged by the point source discharge unit.

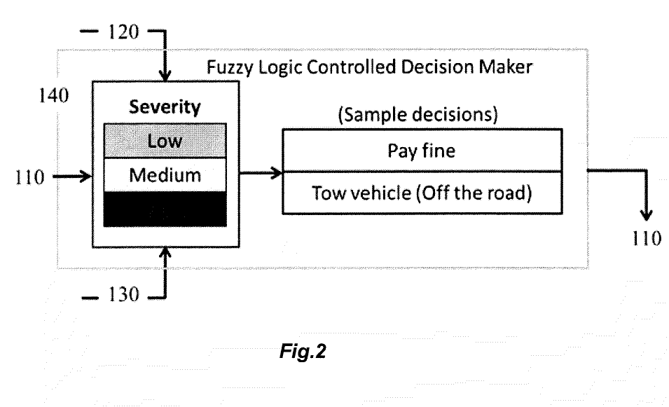

Fuzzy Logic Controlled Decision Maker (140) combines information (static and dynamic) stored in the database (unit 110) with those from the Digital Imaging Unit (unit 120) and the Thermographic Imaging Unit (unit 130) in order to develop a fuzzy rule set that ascertains the extent to which the quantity of smoke (measured using unit 120) and the toxicity (measured via unit 130) contribute to the severity of the air pollution contributions from the point source. The same unit then recommends an appropriate penalty based on predetermined thresholds decided by the appropriate authorities as stored in the database. This decision is used to update the database so that penalties for future violations could take into account past violations and decisions. FIG. 2 below shows summaries the Fuzzy Logic Controlled Decision Maker (FLC DM) and how it interacts with the other units of the device to effectively take decisions aimed at estimating, monitoring and controlling the emissions emanating from different point sources (vehicular, industrial or domestic) of smoke discharge as covered by the disclosure.

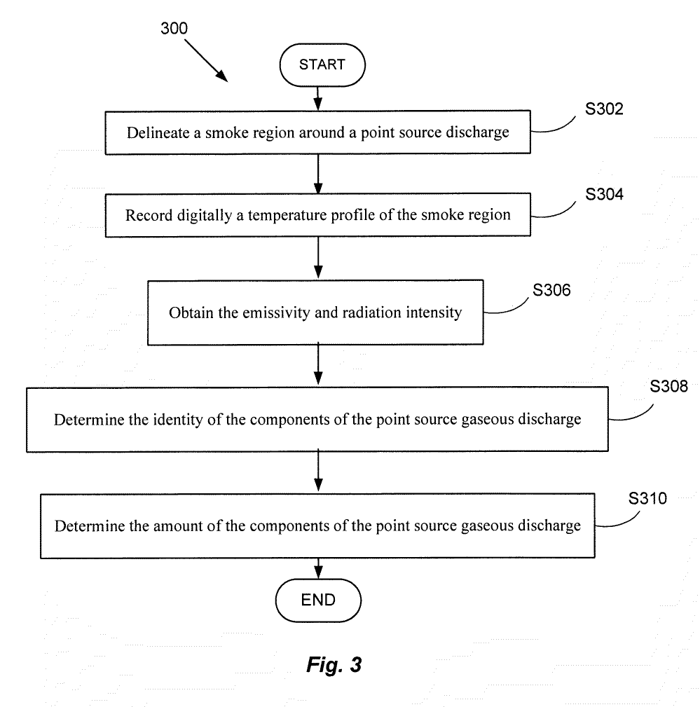

Referring to FIG. 3, a flowchart 300 describes a process for quantifying the amount and toxicity of a point source gaseous discharge without contacting or physically sampling the point source gaseous discharge.

In step 302, a processing circuitry delineates a smoke region around a point source discharge according to a temperature profile around the point source determined from a digital infrared image of the space around the point source.

In step 304, the processing circuitry digitally records a temperature profile of the smoke region, wherein the temperature profile comprises pixels of a digital infrared image, with each pixel representing a temperature.

In step 306, the processing circuitry obtains the emissivity and radiation intensity of one or more components of the point source gaseous discharge in the smoke region from a static database;

In step 308, the processing circuitry determines the identity of the components of the point source gaseous discharge by comparing temperature variations of the temperature profile of the smoke region with the emissivity and radiation intensity from the static database.

In step 310, the processing circuitry determines the amount of the components of the point source gaseous discharge through a fuzzy logic controller by relating the properties of the components with the temperature profile the emissivity of the components in the static database.

The described technology differs from those available in two core areas: target audience/application and underlying technical details. While available technologies are principally designed as maintenance tools targeted at either production line assessment (as engine test beds) before series production or by vehicle owners as tools for improved fuel economy, our proposed technology is mainly targeted at traffic and environmental standards enforcement by the different regulatory authorities. In addition, the same technology can be deployed (with minor tweaking) for the purpose of regulating smoke discharges from homes and industries.

Similarly, owing to their targeted applications, the production line versions of the conventional technologies are often bulky and heavy, making portability almost impossible. In other cases of using the available technologies targeted at the vehicle owners, it is always required that the technology (or a part thereof) be physically mounted to some part of the combustion or exhaust unit of the vehicle. In both cases, a sensor (mostly optical) is required to detect the amount of smoke emitted.

On the contrary, the disclosed system (device or process) is sensor-less contact-less and image based. This means that no physical contact with any part of the smoke discharge unit (rear exhaust pipes in vehicles, industrial or domestic chimneys in the case of industrial or domestic smoke) is required for the system to function. This stems from the fact that the entire technology is image-based relying on only the multiple images of the smoke captured using different state-of-the-art cameras and other data (vehicle type, fuel type, manufacturing details, last inspection, and etc.) already collated and stored by the appropriate authorities. In such a manner, the proposed technology can be easily integrated for better regulation of smoke discharges and enhanced monitoring of environmental (air) pollution by the appropriate authorities.

Gases generally, and those obtained from the burning of hydrocarbons in particular, are characterized by three key features: indefinite volume, indefinite shape and they are mostly colourless (among which many are also odourless). These features make image and/or camera-based approaches to effectively monitor and estimate not only the amount of the smoke discharge but also the likely composition of the constituent molecules in the smoke, and, hence, the smoke's toxicity a very daunting task. Thus far, these challenges have made the idea of a sensor-less non-contact technology to track, estimate and control the smoke emanating from each (vehicular, industrial, or domestic) source non-obvious and abstruse, until now (in this disclosure).

The disclosed system is sensor-less, and so, the need to mount or attach it to any part of the vehicle is eliminated making the disclosed system contact-less. The disclosed systems ability to make use of advanced thermographic and state-of-the-art image processing techniques enhances the acuity of the hitherto undiscernible properties in the smoke discharges emanating from the burning of organic substances.

Since the disclosed system (device or process) is contact-less; it will be easier to deploy and transport. In addition, with appropriate advancement it can be integrated with other traffic and surveillance cameras to better monitor traffic and environmental (air pollution) violations. The fact that the same outline of the module (with minimal tweaking) could be deployed to monitor smoke discharges from varying sources (vehicles, industries, residences, etc.) makes the proposed module more expedient than available ones.

The invention will be easily commercialized because it will provide an easy-to-use, portable and efficient technology to estimate the amount and toxicity of vehicular, industrial and domestic smoke. This is especially important because the World Health Organization is championing the need to regulate air pollution, of which smoke is the main contributing source. Therefore, it is envisaged that authorities at different levels will deploy various technologies to monitor, estimate and regulate the smoke contributions from different sources (vehicular, industrial and domestic) in order to curtail its effect to environmental and healthy well-being of the citizenry.

Furthermore, the claimed advancements may be provided as a utility application, background daemon, or component of an operating system, or combination thereof, executing in conjunction with CPU 400 and an operating system such as Microsoft Windows 7, UNIX, Solaris, LINUX, Apple MAC-OS and other systems known to those skilled in the art.

CPU 400 may be a Xenon or Core processor from Intel of America or an Opteron processor from AMD of America, or may be other processor types that would be recognized by one of ordinary skill in the art. Alternatively, the CPU 400 may be implemented on an FPGA, ASIC, PLD or using discrete logic circuits, as one of ordinary skill in the art would recognize. Further, CPU 400 may be implemented as multiple processors cooperatively working in parallel to perform the instructions of the inventive processes described above.

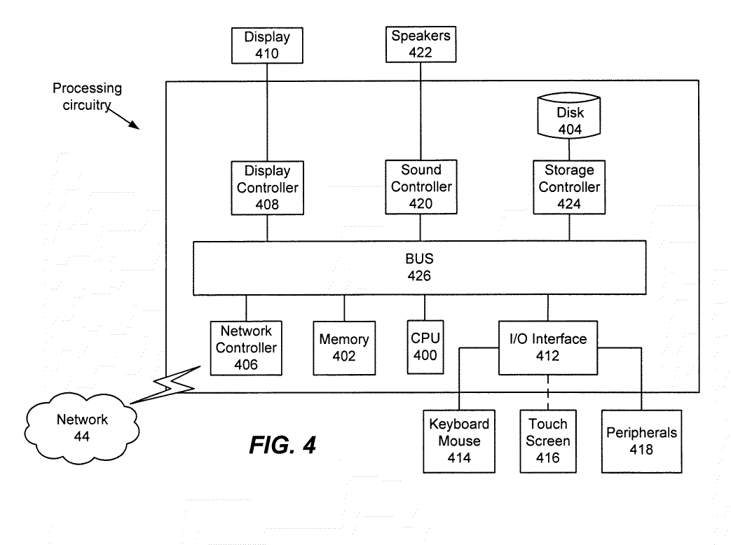

The processing circuitry in FIG. 4 also includes a network controller 406, such as an Intel Ethernet PRO network interface card from Intel Corporation of America, for interfacing with network 44. As can be appreciated, the network 44 can be a public network, such as the Internet, or a private network such as an LAN or WAN network, or any combination thereof and can also include PSTN or ISDN sub-networks. The network 44 can also be wired, such as an Ethernet network, or can be wireless such as a cellular network including EDGE, 3G and 4G wireless cellular systems. The wireless network can also be WiFi, Bluetooth, or any other wireless form of communication that is known.

The device further includes a display controller 408, such as a NVIDIA GeForce GTX or Quadro graphics adaptor from NVIDIA Corporation of America for interfacing with display 410, such as a Hewlett Packard HPL2445w LCD monitor. A general purpose I/O interface 412 interfaces with a keyboard and/or mouse 414 as well as a touch screen panel 416 on or separate from display 410. General purpose I/O interface also connects to a variety of peripherals 418 including printers and scanners, such as an OfficeJet or DeskJet from Hewlett Packard.

A sound controller 420 is also provided in the device, such as Sound Blaster X-Fi Titanium from Creative, to interface with speakers/microphone 422 hereby providing sounds and/or music.

The general purpose storage controller 424 connects the storage medium disk 904 with communication bus 426, which may be an ISA, EISA, VESA, PCI, or similar, for interconnecting all of the components of the device. A description of the general features and functionality of the display 410, keyboard and/or mouse 414, as well as the display controller 308, storage controller 424, network controller 406, sound controller 420, and general purpose I/O interface 412 is omitted herein for brevity as these features are known.

It is to be understood that the present invention is not limited to the embodiments described above, but encompasses any and all embodiments within the scope of the following claims.

1. A process for quantifying the amount and toxicity of a point source gaseous discharge without contacting or physically sampling the point source gaseous discharge, comprising:
delineating a smoke region around a point source discharge according to a temperature profile around the point source determined from a digital infrared image of the space around the point source;
digitally recording a temperature profile of the smoke region, wherein the temperature profile comprises pixels of a digital infrared image, with each pixel representing a temperature;
obtaining the emissivity and radiation intensity of one or more components of the point source gaseous discharge in the smoke region from a static database;
determining the identity of the components of the point source gaseous discharge by comparing temperature variations of the temperature profile of the smoke region with the emissivity and radiation intensity from the static database; and
determining the amount of the components of the point source gaseous discharge through a fuzzy logic controller by relating the properties of the components with the temperature profile the emissivity of the components in the static database.

2. The process of claim 1, wherein the step of digitally recording a temperature profile of the smoke region comprises using temperature variations to obtain the temperature of every pixel in the digital infrared image.

3. The process of claim 1, wherein the step of obtaining the emissivity and radiation intensity of the components of the point source gaseous discharge comprises calculating the smoke radiation intensity using the equation:
R_{S}=εₛσT⁴
wherein R_{S} is the smoke radiation intensity in /m², εₛ is the dimensionless smoke emissivity; σ is the Stefan-Boltzmann constant=5.67×10⁻⁸ W/m², and T is temperature in Kelvin.

4. The process of claim 1, wherein the step of obtaining the emissivity and radiation intensity of the components of the point source gaseous discharge comprises using a lambda calculation to compare all of oxygen in the gaseous discharge to all of Carbon and Hydrogen in the gaseous discharge.

5. The process of claim 1, wherein the step of obtaining the emissivity and radiation intensity of the components of the point source gaseous discharge comprises obtaining the emissivity and radiation intensity of one or more components of the point source gaseous discharge in the smoke region from a static database, which is a smoke source static data together with dynamic properties about the gaseous discharge at the time of measurement.

6. The process of claim 5, wherein the dynamic properties about the gaseous discharge include at least one of weather properties and time properties.

7. The process of claim 6, wherein the weather properties include at least one of a temperature property, a wind property and a fog property.

8. The process of claim 6, wherein the physical conditions of the surrounding at the instant of the measurements include one of a cool morning breeze, a cool evening breeze, and a heat of a day.

9. A system for quantifying the amount and toxicity of a point source gaseous discharge without contacting or physically sampling the point source gaseous discharge, comprising:
a camera capable of capturing digital infrared images; and
processing circuitry coupled with the camera, the processing circuitry configured to:
delineate a smoke region around a point source discharge according to a temperature profile around the point source determined from a digital infrared image of the space around the point source;
digitally record a temperature profile of the smoke region, wherein the temperature profile comprises pixels of a digital infrared image, with each pixel representing a temperature;
obtain the emissivity and radiation intensity of one or more components of the point source gaseous discharge in the smoke region from a static database;
determine the identity of the components of the point source gaseous discharged by comparing temperature variations of the temperature profile of the smoke region with the emissivity and radiation intensity from the static database; and
determine the amount of the components of the point source gaseous discharge through a fuzzy logic controller by relating the properties of the components with the temperature profile the emissivity of the components in the static database.

10. The system of claim 9, wherein the processing circuitry uses temperature variations to obtain the temperature of every pixel in the digital infrared image.

11. The system of claim 10, wherein the processing circuitry calculates the smoke radiation intensity using the equation:
R_{S}=εₛσT⁴
wherein R_{S} is the smoke radiation intensity in /m², εₛ is the dimensionless smoke emissivity; σ is the Stefan-Boltzmann constant=5.67×10⁻⁸ W/m², and T is temperature in Kelvin.

12. The system of claim 10, wherein the processing circuitry uses a lambda calculation to determine the amount of all of oxygen in the gaseous discharge to all of Carbon and Hydrogen in the gaseous discharge.

13. The system of claim 10, wherein the processing circuitry obtains the emissivity and radiation intensity of one or more components of the point source gaseous discharge in the smoke region from a static database, which is a smoke source static data together with dynamic properties about the gaseous discharge at the time of measurement.

14. The system of claim 13, wherein the dynamic properties about the gaseous discharge include at least one of weather properties and time properties.

15. The system of claim 13, wherein the weather properties include at least one of a temperature property, a wind property and a fog property.

16. The system of claim 13, wherein the time properties include at least one of a cool morning breeze, and a heat of a day.

17. A non-transitory computer-readable medium storing executable instructions, which when executed by a computer processor, cause the computer processor to execute a method comprising:
delineating a smoke region around a point source discharge according to a temperature profile around the point source determined from a digital infrared image of the space around the point source;
digitally recording a temperature profile of the smoke region, wherein the temperature profile comprises pixels of a digital infrared image, with each pixel representing a temperature;
obtaining the emissivity and radiation intensity of one or more components of the point source gaseous discharge in the smoke region from a static database;
determining the identity of the components of the point source gaseous discharged by comparing temperature variations of the temperature profile of the smoke region with the emissivity and radiation intensity from the static database; and
determining the amount of the components of the point source gaseous discharge through a fuzzy logic controller by relating the properties of the components with the temperature profile the emissivity of the components in the static database.
